(19) United States
(12) Patent Application Publication
(10) Pub. No.: US 2008/0294504 A1
(43) Pub. Date: Nov. 27, 2008

(54) Method of Evaluating a Project Manager of a Project of a Provider

(76) Inventors: William A. Mortensen, McDonald, PA (US); David F. Bechtol, Presto, PA (US)

Correspondence Address: Martin J. Moran;Eaton Electrical, Inc., Technology & Quality Center, 170 Industry Drive, RIDC Part West, Pittsburgh, PA, 15275-1032, US

(21) Appl. No.: 11/752,439

(22) Filed: May 23, 2007

(51) Int. Cl. G06Q 10/00

(52) U.S. Cl. 705/11

(57) ABSTRACT

A method evaluates a project manager of a project of a provider, the project being for a customer. The method includes utilizing a project manager scorecard comprising a plurality of predetermined project phases which are common to a plurality of different projects, and including with each of the predetermined project phases a plurality of predetermined project milestones which are common to the different projects. A potential value is pre-assigned to each of the predetermined project milestones for the different projects. The project manager is evaluated with respect to the predetermined project milestones and an assigned value, which is less than or equal to the potential value, is responsively assigned for each of the predetermined project milestones. A sum is determined of the assigned value for each of the predetermined project milestones. The performance of the project manager on the project of the provider is evaluated based upon the sum.

### BACKGROUND OF THE INVENTION

1. Field of the Invention

This invention pertains generally to evaluation methods and, more particularly, to such methods for evaluating project managers.

2. Background Information

“Management by objectives” and “pay-for-performance” and are well known concepts.

Management by objectives (MBO) is a process of agreeing upon objectives within an organization so that management and employees agree to the objectives and understand what they are. MBO substitutes for good intentions a process that requires rather precise written description of particular objectives (for the period ahead) and timelines for their monitoring and achievement. The process requires that the manager and the employee agree to what the employee will attempt to achieve in the period ahead, and (very important) that the employee accept and agree to the objectives (otherwise commitment will be lacking). MBO is often achieved using set targets. MBO introduced the SMART criteria in which the MBO objectives are “SMART” (Specific, Measurable, Agreed, Realistic, and Time-specific). However, it has been reported in recent years that this style of management receives criticism in that it triggers employees' unethical behavior of distorting the system or financial figures to achieve the targets set by their short-term, narrow bottom-line, and completely self-centered thinking. See http://en.wikipedia.org/wiki/Management_by_objectives, 2007.

Pay-for-performance systems link compensation to measures of work quality or goals. It is believed that a majority of companies in the United States connect at least part of an employee's pay to one or more measures of performance.

Some scholars contend that pay-for-performance can cast a pall over self-esteem, teamwork and creativity. Conversely, other scholars argue that the real problem is that incentives work too well. “Specifically, they motivate employees to focus excessively on doing what they need to do to gain rewards, sometimes at the expense of doing other things that would help the organization . . . ” Lagace, M., “Pay-for-Performance Doesn't Always Pay Off,” Harvard Business School Working Knowledge, Apr. 14, 2003, 4 pp.

Some known incentive and evaluation systems for project managers are subjective and are based on customer ratings and/or management's perception of the effectiveness of the project manager on a number of projects.

For example, it is known to incentivize project managers on the dollar volume of projects that they are managing. The actual evaluation of the project manager's strengths and weaknesses happens periodically as part of their annual or semi-annual performance reviews.

Other known incentive systems for project managers involve measurement of margin or direct financial performance on a project. However, these approaches are far easier for a contractor, rather than a provider, since all of the material is bought for the particular project, labor is directly tied to that project, and overhead is directly proportioned to that specific project. This, however, is not the case with manufacturers or suppliers for which overheads and product costs are not easily tied to specific projects.

Accordingly, there is room for improvement in methods of evaluating project managers.

### SUMMARY OF THE INVENTION

These needs and others are met by embodiments of the invention, which employ a project manager scorecard and an incentive plan that stems from the project manager scorecard, in order to provide a direct and systematic way to evaluate a provider's project manager. By measuring and incentivizing performance against predetermined project milestones that lead to financial performance, suitable financial performance is achieved along with directly driving the project manager's performance against the scorecard.

The disclosed method may consider financial performance changes that occur from when a project manager is assigned to a project to when the project completes.

In accordance with one aspect of the invention, a method evaluates a project manager of a project of a provider, the project being for a customer. The method comprises: utilizing a project manager scorecard comprising a plurality of predetermined project phases which are common to a plurality of different projects; including with each of the predetermined project phases a plurality of predetermined project milestones which are common to the different projects; pre-assigning a potential value to each of the predetermined project milestones for the different projects; evaluating the project manager with respect to the predetermined project milestones and responsively assigning an assigned value, which is less than or equal to the potential value, for each of the predetermined project milestones; determining a sum of the assigned value for each of the predetermined project milestones; and evaluating performance of the project manager on the project of the provider based upon the sum.

As another aspect of the invention, a method evaluates a project manager of a plurality of different projects of a provider, the projects being for a number of customers. The method comprises: utilizing a project manager scorecard comprising a plurality of predetermined project phases which are common to the different projects; including with each of the predetermined project phases a plurality of predetermined project milestones which are common to the different projects; pre-assigning a potential value to each of the predetermined project milestones; evaluating the project manager with respect to the predetermined project milestones and responsively assigning an assigned value, which is less than or equal to the potential value, for each of the predetermined project milestones and for each of the different projects; for each of the different projects, determining a sum of the assigned value for each of the predetermined project milestones; and evaluating performance of the project manager on the different projects based upon the sum for each of the different projects.

### BRIEF DESCRIPTION OF THE DRAWINGS

A full understanding of the invention can be gained from the following description of the preferred embodiments when read in conjunction with the accompanying drawings in which:

FIG. 1 is a block diagram of four process areas of a project in accordance with embodiments of the invention.

FIG. 2 is a breakdown of process evaluation weightings for the process areas of FIG. 1.

FIGS. 3A-3C form a process management process scorecard in accordance with another embodiment of the invention.

FIG. 4 is a plot of project management scores versus changes in the net project margin from order entry to close of the project in accordance with embodiments of the invention.

FIG. 5 is a project management monthly report for a project manager in accordance with another embodiment of the invention.

FIG. 6 is a risk assessment evaluation in accordance with another embodiment of the invention.

### DESCRIPTION OF THE PREFERRED EMBODIMENTS

As employed herein, the term “number” refers to the quantity one or an integer greater than one (i.e., a plurality).

As employed herein, the term “manufacturer” means a number of persons and/or business entities that produce, make, fabricate, distribute and/or supply equipment, finished goods and/or information to or for a customer.

As employed herein, the term “supplier” means a number of persons and/or business entities that distribute and/or supply equipment, finished goods and/or information to or for a customer.

As employed herein, the term “provider” means a manufacturer or a supplier.

As employed herein, the term “contractor” means a number of persons and/or business entities that act as a systems integrator and/or perform work in connection with equipment, finished goods and/or information from a provider for a customer. A contractor expressly excludes a manufacturer. Instead, a contractor may, for example, buy components, mount components and/or provide mounting structures for components in accordance with specified designs for a customer.

As employed herein, the term “customer” means a number of persons and/or business entities that purchase or receive equipment, finished goods and/or information from a contractor or provider.

As employed herein, the term “project” means a specific plan or design, and/or a legal contract in connection with providing equipment, finished goods and/or information from a provider to or for a customer. A project typically is funded by capital expenditures as opposed to an operating budget. Non-limiting examples of projects include projects in the fields of switchgear (e.g., without limitation, low voltage; medium voltage; high voltage), HVAC (heating, ventilation and air conditioning), electrical distribution systems, uninterruptible power supply systems, and generators.

As employed herein, the term “project manager” means a number of persons (e.g., typically, one person) responsible for planning, managing, executing, reviewing, evaluating and/or monitoring a project.

As employed herein, the term “project scorecard” means a structure or method that breaks down a project chronologically into a plurality of predetermined project milestones and, for each of the predetermined project milestones, assigns a corresponding weighted value associated with a project manager meeting, partially meeting or missing the corresponding predetermined project milestone.

As employed herein, the term “milestone” means, prior to completion of a project, a mutually agreed upon date or result for a specific project task or other project event. When used in operative relation to the project scorecard, a specific “milestone” is common to a plurality of different projects and, preferably, is common to all projects.

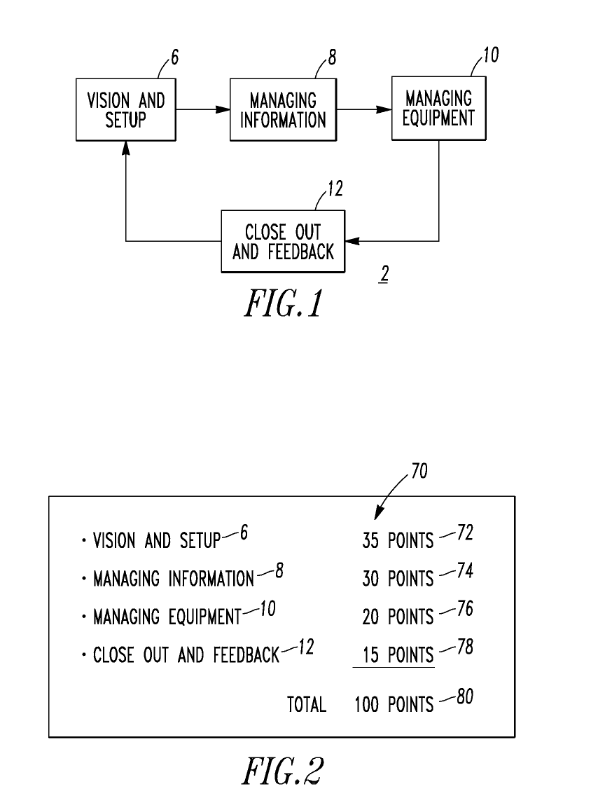

Referring to FIGS. 1, 2 and 3A-3C, a project 2 and a project management process scorecard (or project scorecard) 4 include four phases: (1) vision and set-up 6; (2) managing information 8; (3) managing equipment 10; and (4) close out and feedback 12. All four of these phases 6,8,10,12 are common to every project.

The disclosed project scorecard 4 is the basis for evaluation of project manager performance, since it shows objectively whether the project manger is doing those things that lead to successful projects.

The project scorecard 4 may preferably also be an outline for a training and development program (not shown) operatively associated with improving project manager performance. For example, strategies for achieving predetermined project milestones in all kinds of different circumstances are developed and shared in the training and development program. These strategies may include technical as well as softer topics, such as, for example, negotiating skills. For example, training and development may be targeted based upon a number of the predetermined project milestones, such as 50,52,54,56,58, and each of the actual points 96 therefor. In this manner, if the project manager scores poorly or inadequately on certain project milestones, then a corresponding training and development program is needed. Conversely, if the project manager scores well on certain project milestones, then valuable training and development resources should preferably be devoted to other project managers who score poorly or inadequately on those project milestones.

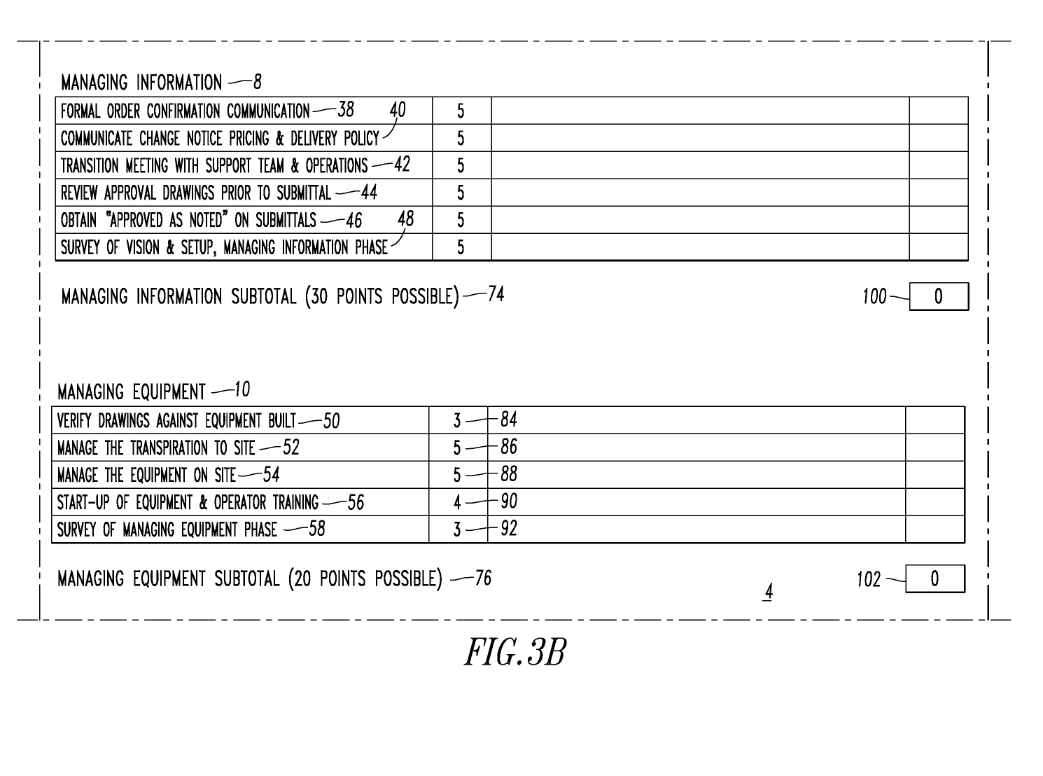

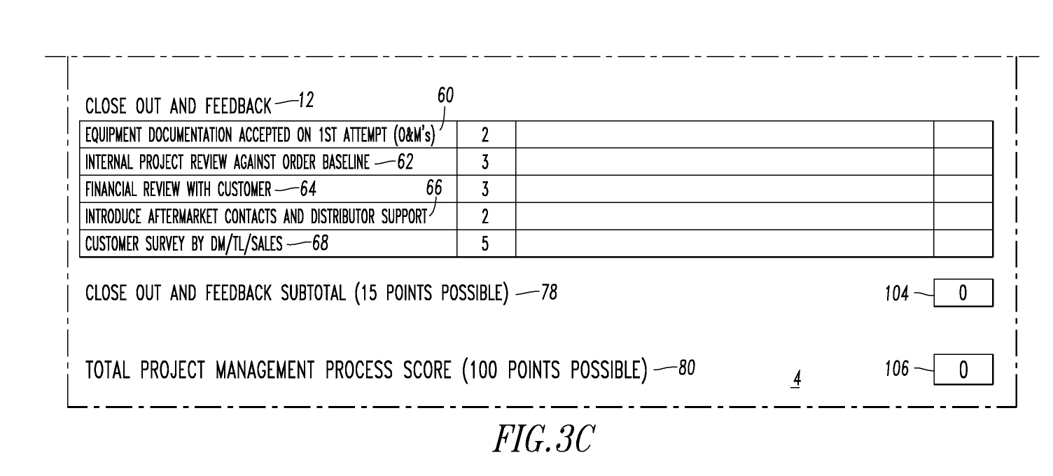

As shown in FIGS. 3A-3C, the vision and set-up phase 6 considers: (1) forecasting upcoming projects with sales 14; (2) risk assessment completed and approved by the corresponding pricing organization 16; (3) establish project milestones (scope timing requirements) 18; (4) obtain terms and conditions approval 20; (5) project review prior to order close 22; (6) the project manager has a role in order closing 24; (7) meet contacts (e.g., without limitation, customer; contractor) face-to-face 26; (8) document any unclear areas (where information is needed to proceed) 28; (9) establish order baseline (e.g., without limitation, revisions; addenda) 30; (10) establish project milestone matrix 32; and (11) rationalize plant schedules to project milestones 34. The last five items pertain to a transition meeting 36.

The managing information phase 8 considers: (1) formal order confirmation communication (e.g., without limitation, letter) 38; (2) communicate change notice pricing and delivery policy 40; (3) transition meeting with support team and operations 42; (4) review approval drawings prior to submittal 44; (5) obtain “approved as noted” on submittals 46; and (6) survey of vision and setup (managing information phase) 48.

The managing equipment phase 10 considers: (1) verify drawings against equipment built (e.g., without limitation, witness test or digital photographs; verify coordination items) 50; (2) manage the transportation to site 52; (3) manage the equipment on site (e.g., offloaded and stored properly; verify packing lists and material received) 54; (4) start-up of equipment and operator training 56; and (5) survey of managing equipment phase (e.g., without limitation, jobsite contacts) 58.

The close out and feedback phase 12 considers: (1) equipment documentation accepted on first attempt (e.g., without limitation, Operation and Maintenance Manuals) (O&Ms) 60; (2) internal project review against order baseline 62; (3) financial review with customer 64; (4) introduce after market contacts and distributor support 66; and (5) customer survey by District Manager (DM) (e.g., without limitation, a front line, field based sales manager), Team Leader (TL) (e.g., without limitation, in a relatively large office, a market segment focused front line sales manager reporting to the District Manager) and sales 68.

Hence, it will be appreciated that a number of the above described predetermined project milestones are related to a number of persons responsible to the provider and a number of persons responsible to the customer.

The project scorecard 4 of FIGS. 3A-3C provides: (1) a milestone based definition of the roles and responsibilities of involved parties (e.g., provider (including, but not limited to, the provider's project manager); customer; contractor(s)) of the project; (2) tracking of progress against project milestones as the project progresses; (3) an evaluation system for the project manager; (4) a training and development program for the project manager; (5) an incentive structure for the project manager that drives the right behavior; (6) a linkage between project management performance and financial results that has been or can be tested and verified; and (7) a linkage between a project management and customer satisfaction that has been or can be tested and verified. The customer surveys embedded within, and at the end of, a project give the provider specific feedback on customer satisfaction against project management performance in the specific part of the project that is being scored and surveyed.

The disclosed method is built around project management functions that a provider fulfils, as opposed to the functions of a contractor (e.g., systems integrator) on a jobsite. A significant portion of the project scorecard 4 deals with communications from the provider (e.g., from the project manager) to a number of contractors (or to the customer of the provider) on or about a customer's jobsite.

The milestone based definition of the roles and responsibilities of involved parties defines the roles and responsibilities of the provider's project manager (and, perhaps, the customer's project manager as it relates to dealing with the provider), but not the performance of the customer's project management functions. In contrast, the customer's project manager deals with, for example, coordination of trades at the customer's jobsite, managing labor and managing material from a variety of different providers. The disclosed method and project scorecard 4 deal with, for example and without limitation, the provider end of managing the equipment, the approval information (e.g., documentation) specific to the equipment being supplied, the logistics of delivering the equipment, and commissioning and operator training on the equipment.

The disclosed method adds value to the customer by reducing or eliminating the pressure of managing the provider's equipment. For example, a service (i.e., implementing the method) may be sold (e.g., without limitation, to the customer; to a contractor; to another industrial customer) in which the provider's project manager employs the method. This may be done, for example, based upon the value supplied to the customer by such project manager utilizing the method.

Another application of the disclosed method is through use of the method by another provider, and not by a contractor or by an industrial customer. By using the disclosed method, another provider can provide relatively more value to its project customers. It is believed that this provider focus is not used by known project management systems and methods used by contractors, customers and system integrators.

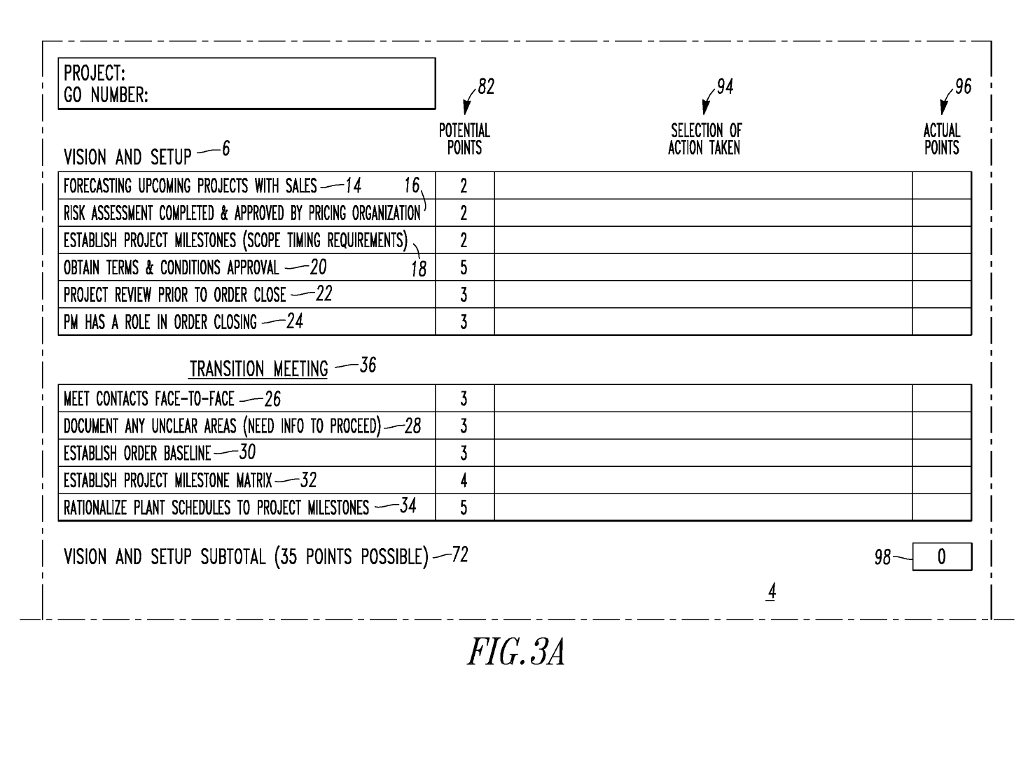

Referring to FIG. 2, the four phases 6,8,10,12 of the project scorecard 4 (FIGS. 3A-3C) preferably correspond to predetermined potential values (e.g., points) 70. In this example, the predetermined potential values 72, 74, 76 and 78 are 35 points, 30 points, 20 points and 15 points for the respective phases 6, 8, 10 and 12, although any suitable potential values may be employed for these phases. The total potential value 80, in this example, is 100 points, although any suitable total potential value may be employed.

FIGS. 3A-3C show that predetermined potential points 82 are employed for each of the items of the four phases 6,8,10,12. For example, for the managing equipment phase 10, the items 50, 52, 54, 56 and 58 employ predetermined potential values 84, 86, 88, 90 and 92 of 3, 5, 5, 4 and 3, respectively, which total 20 points, although any suitable potential values may be employed. It will be appreciated that other predetermined potential values 82 are employed by the items of the other three phases 6,8,12.

The project scorecard 4 preferably includes a selection of action taken 94 for each of the items of each of the phases 6,8,10,12. This may assist the evaluator of the project manager with the assignment of the actual points 96 for those items as will be discussed. In turn, the actual points 96 for each of the phases 6, 8, 10 and 12 are manually or automatically summed to provide sub-totals 98, 100, 102 and 104, respectively. Then, the sub-totals 98,100,102,104 are manually or automatically summed to provide a total score 106 for the project scorecard 4.

The disclosed project scorecard 4 may be employed as the basis for an overall project performance rating system, as an evaluation tool for the provider's project manager (e.g., without limitation, a relatively higher total score 106 indicates a relatively higher level of performance by the project manager), as a training program outline (e.g., without limitation, to enable the project manager to learn specific techniques to achieve the milestones under different project circumstances), and as an outline for an incentive system. All of these elements focus on the unique needs of the project managers of providers.

For example, the incentive system may be a points-based system where the project manager earns points for meeting milestones and completing tasks throughout the project. This is not a volume or purely margin-based system. Instead, if the project manager is doing the right things, then the margin takes care of itself. Hence, the project scorecard 4 measures and rewards the “right” project manager behaviors, instead of the results of those behaviors. The incentive system may be run, for example, in parallel with a conventional volume-based incentive plan for a predetermined period of time (e.g., without limitation, a number of calendar quarters). This allows the provider to verify the suitable compensation (e.g., without limitation, dollars per point), in order to make sure that it fits with the provider's financial budget. Preferably, risk of the particular project is assessed (FIG. 6) as part of the incentive plan, since scoring a relatively greater number of points on a project of relatively greater risk should be rewarded as compared to, for example, scoring a relatively fewer number of points on a project of relatively less risk.

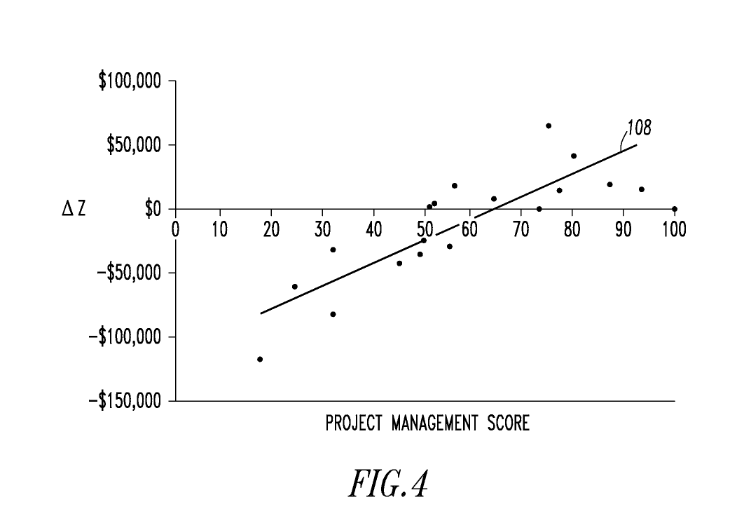

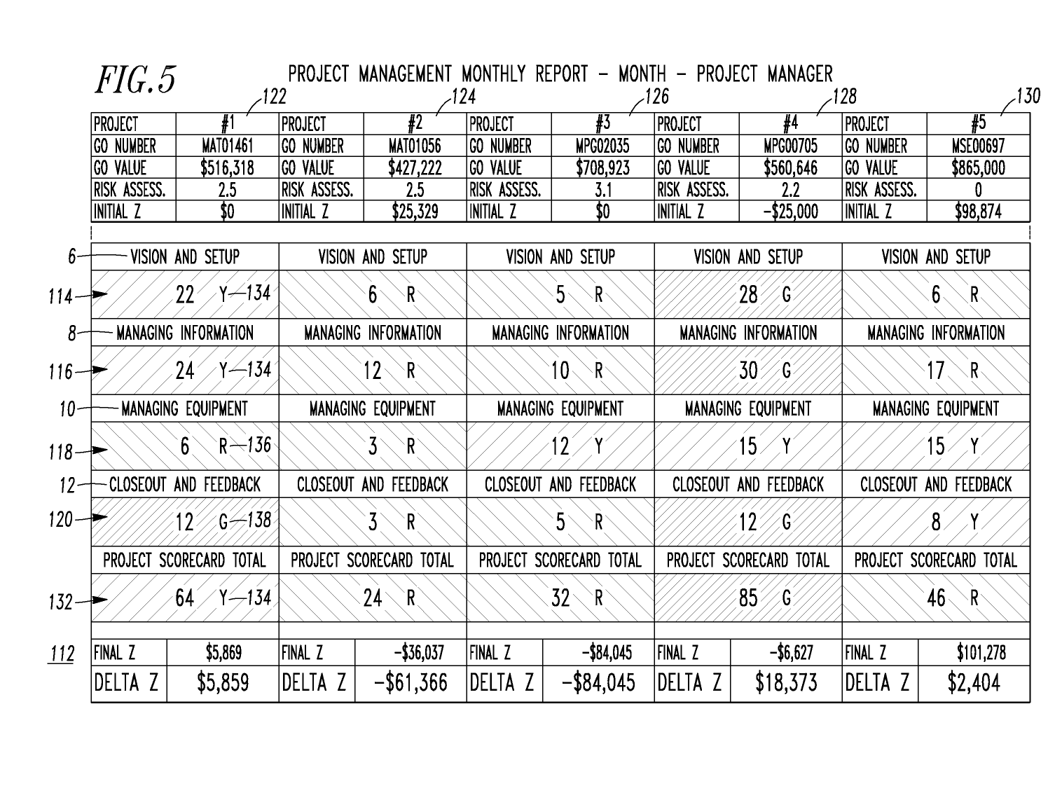

It is believed that there is a direct link between a relatively higher project manager scorecard total score 106 and the financial results of an individual project. The project scorecard 4 puts a relative score 96 on effective project management best practices (i.e., the various items of the four phases 6,8,10,12) that are preferably generated by statistical data from a range of projects (as shown in FIG. 4). This answers the question: “How do you measure the bad things that don't happen because you avoided them with effective project management?” As shown in FIG. 4, the total scores 106 from various project scorecards 4 (project management score) are plotted against the financial performance (ΔZ), as will be described, of the corresponding projects from the later of order entry or the project being assigned to the project manager, to the close of the project. The budgeted margin of the project at the time of sale is not considered. Only the change in margin after the project is assigned to a project manager is considered.

For example, as shown in FIG. 4, a significant number of past projects were reviewed and scored, in order to verify the relationship between the project manager's project scorecard total score 106 and the financial performance of the project after the project manager was assigned. Since the past projects did not employ all of the scorecard items, it was impossible for a past project to score the full amount of points 80 of FIG. 2 (e.g., without limitation, 100). However, the various project managers all use some of those items. A range of scores on the example projects was from 17 to 92 in FIG. 4. When the financial performance of all of the projects is plotted versus those scores, there is a clear trend 108 that all of the projects followed-the higher the score, the better the financial performance. This shows that there is a suitable correlation between the total scores 106 and the financial performance of the projects. Hence, this confirms that future projects will continue to benefit from relatively higher scores.

The trend 108 of FIG. 4 verifies that the closer the method is followed (and, therefore, the more points that are earned on the project scorecard 4), the better the financial performance of the project. The ΔZ account measures that performance. Hence, the higher the project manager's score, the better the financial performance of the project.

The project scorecard 4 is preferably the same for every project. The items of the project scorecard 4 are done in the same order for every project. Hence, consistency in this approach allows the provider to provide better service to its customers and, also, to teach, evaluate and pay the project managers in-line with delivering consistent performance to those customers.

### EXAMPLE 1

The following scoring guidelines provide example details on how to score different levels of performance against a particular item in the project scorecard 4, in order to ensure consistent application across all projects and all project managers. These relate to the selection of action taken 94 and the actual points 96 of FIGS. 3A-3C.

In general, to get all of the potential points 82 on a particular item, there should preferably be regular, scheduled activities and/or documented evidence that the item is consistently done. If the item is generally done, but less formally, verbally only, or not in every instance, then the scoring guideline should be roughly half of the potential points 82 for the particular item. If an item was done in a cursory or informal way, then a nominal point credit may be subject to a judgment call by the scorer. On a two point item, this might result in a “0” score on the item, but on a five point item, this might result in a “1” score.

The “Vision & Setup” phase 6 of the project scorecard 4 is intended to evaluate the quality of communication between the sales teams and the project manager (PM). Here, relevant questions include: How involved is the PM in the pre-order phase of projects with the sales teams? Is the PM included in construction meetings? Do sales engineers (SEs) know the load capacity of the PM? Does the PM have a vision of potential upcoming orders?

The “Vision & Setup” phase 6 includes: forecasting upcoming projects with sales 14; risk assessment being completed and approved 16; establishing project milestones 18; obtaining approval of terms and conditions 20; project review prior to order close 22; the project manager has a role in order closing 24; and the transition meeting 26.

Forecasting 14 considers: Is this formally communicated? Is the PM's name assigned to upcoming potential projects?

Risk assessment 16 (as shown for example, in FIG. 6) determines areas to focus on and quantifies risks. Is this or another formal tool used? Complexity and sheer project size have a good deal to do with filling the capacity of project managers. A Risk Assessment tool 110 (FIG. 6) is preferably employed to acknowledge that relatively larger and more complex projects are worth more points in the incentive and evaluation systems than relatively smaller and less complex projects. The Risk Assessment tool 110 is used before the start of the project (e.g., without limitation, pre-order), as an indicator of how much money or margin will be needed in a project to ensure that it finishes at an acceptable level. Risk assessment 16 does not figure into financial measurements. For example, even relatively high risk projects, if run properly (and, thus, earning a relative high project manager total score 106), end up having positive Z movement (i.e., +ΔZ) from the beginning to the end of the project. The Risk Assessment tool 110 may, preferably, be employed in an incentive system. Preferably, the final ΔZ is not directly tied to compensation of the project manager, but is at least integral to the performance evaluation of the project manager.

As a non-limiting example, a “normal” sized and “normal” complexity project is worth 30 points in the incentive system. A relatively larger sized and more complex project would be factored up using a suitable risk assessment score and a project volume factor so that it may be worth 40, 50 or more points. Hence, this compensates the project manager for performing on relatively more difficult projects.

For obtain terms and conditions approval 20, in many instances, the provider never obtains formal approval and plays “the battle of the [UCC] forms” with the customer. If this is the case, then partial points can be awarded if the PM is aggressively keeping ahead in that “battle”.

Project review 22 and the project manager has a role in order closing 24 consider: Does sales act independently and throw orders over the fence or does the PM get to examine the project before the order is taken, in order to put fresh eyes and post order perspective into the process? Is the PM used as part of the value offering on the project? Is the provider selling the value that a dedicated PM is worth something to the customer?

The transition meeting 36 is a customer meeting with both sales and the PM present. A formal meeting is preferred. Varying degrees of time and formality are evident depending on a number of variables, but in many cases these meetings are not done. If there is not an identifiable event where these activities were integral to the agenda, then points must be deducted from the total potential points 82 for the corresponding items.

Rationalize plant schedules to milestones 34 considers that the PM has to have milestones to get any points here. If such milestones exist, then is there a process in place to match items to the milestone schedule and communicate any conflicts to either the plant, the customer or both?

The “Managing Information” phase 8 of the project scorecard 4 includes: formal order confirmation communication 38; communicate change notice pricing and delivery policy 40; transition meeting with support team and operations 42; review approval drawings prior to submittal 44; obtain “approved as noted” on submittals 46; and survey of vision and setup (managing information phase) 48.

Formal order confirmation 38 is focused on written correspondence. The more detail and clarification, the more points should be awarded. If a letter or email is general and does not reference specific issues regarding the project, then points must be deducted from the total potential points for this item.

Communication change notice pricing and delivery policy 40 considers: Have we spelled out to the customer formally that changes during different phases of the project will be handled differently? For example, a change before drawings are produced is less expensive than the same change after equipment is released.

Clean Order Entry Checklists are formal documents that various providers employ. When they are done relatively early, even if it means that order entry is delayed, it is better. Partial points can be awarded for prompt submittal of these documents if after order entry. Clean Order Entry Checklists are a tool used as part of the transition meeting with support team and operations 42. This is an internal meeting where specific requirements from the customer transition meeting are communicated to all internal stakeholders on the project. Clean Order Entry Checklists are required by the product factories to confirm various technical items. One non-limiting example of an item included would be the size of the customer's cables feeding into and out of the provider's equipment. The price and other commercial aspects are not affected, but the correct provisions need to be included in the equipment.

Review approval drawings prior to submittal 44 considers that the best practice is for the PM to do a complete review of the approval drawings before sharing them with the customer. Hence, mistakes and misinterpretations are corrected and the drawings may need to be re-issued.

Obtain “Approved as Noted” on submittals 46 considers that taking a delay at this stage of the project is better than risking a “Revise and Resubmit” cycle. Full points should only be awarded where a summary of clarifications and any assumptions are included with approval drawings to facilitate approval on the first drawing cycle. One drawing cycle is not realistic in some situations, so the scorer will have to determine a best judgment as to whether the minimum number of drawing cycles possible was achieved.

Survey of vision and setup and managing information phase 48 considers the advantages of measuring the most important initial phases 6,8 of the project early in the project cycle rather than waiting until the end of the project, which only gives good customer feedback on the latter phases of the project.

The “Managing Equipment” phase 10 of the project scorecard 4 considers: verify drawings against equipment built 50; manage the transportation to site 52; manage the equipment on site 54; start-up of equipment and operator training 56; and survey of managing equipment phase 58.

Verify drawings against equipment built 50 considers that witness tests are the best way to do this, but are not always possible. Digital photographs or another suitable method of making sure that the customer's drawings have been matched to the equipment before shipment is desired. Here, there is the scorer's judgment call as to the actual points 96 for this item. The more rigorous and complete the process, the more actual points should be awarded.

Manage the transportation to site 52 considers communication of shipping reference information and schedules, carrier contact information, equipment needed to off load equipment and any special instructions. The more formal the communication, the more actual points 96 for this item should be awarded.

Manage the equipment on site 54 considers formal communication giving on site storage instructions and detailed instructions for inspecting for damage in transit. This insulates the providers from back charges later in the project.

Start-up of equipment and operator training 56 is usually a separate order item. If it is not a part of the order, then it should be communicated formally that the service is available for an additional cost and is recommended to ensure a smooth commissioning process. If it is included in the order, then what is involved is scheduling engineering services time to conduct the training and providing to the service engineer the scope of work and equipment details.

Survey of managing equipment phase 58 is intended to get specific feedback on this managing equipment phase 10 mainly from the customer contacts on the job site as opposed to the front office.

The “Close Out and Feedback” phase 12 of the project scorecard 4 considers: equipment documentation accepted on first attempt 60; internal project review against order baseline 62; financial review with customer 64; introduce after market contacts and distributor support 66; and customer survey 68.

Equipment documentation accepted on first attempt 60 considers: Were the Operation and Maintenance Manuals (O&Ms) and other documentation accepted by the customer on the first submittal? This is really a “Yes or No” question.

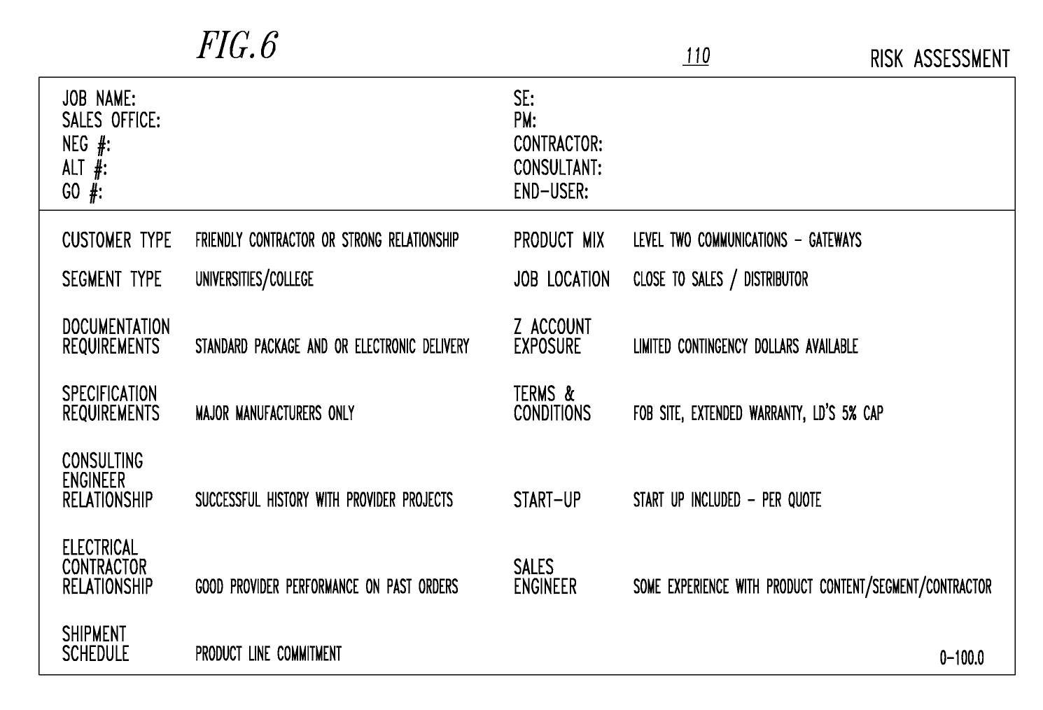

Preferably, the project scorecard 4 employs a periodic (e.g., without limitation, monthly) report format 112 (as shown in FIG. 5) that makes performance on a number of projects, each of which moves forward in different phases, visible to both the project manager and his/her management. Internal project review against order baseline (e.g., ΔZ (or Delta Z) account summary) is intended to track financial performance and especially the changes to the position of the project from order entry to project close. In the project management monthly report format 112, the ΔZ account is an internal account where additional margin is collected above the authorized plant levels both on the original order and on change notices. Back charges, premium freight, sales errors and commercial concessions related to the job are deducted from this account. The ΔZ account balance from the beginning of a project to the end of the project captures the sum total of the extra margin taken in and all of the concessions made on a particular project. In short, the ΔZ account balance measures the financial performance of the project manager regardless of the purchase price of the project, as sold.

As shown in FIG. 5, the periodic report 112 includes sub-totals 114,116,118,120 for each of the predetermined project phases 6,8,10,12 for the various different projects 122,124,126,128,130 of the project manager. Preferably, these sub-totals 114,116,118,120 and the sum 132 for the corresponding project are displayed with a corresponding indicator 134,136,138 of the performance of the project manager. These indicators 134,136,138 are selected from a plurality of different indicators (e.g., without limitation, yellow; red; green, respectively) corresponding to relative performance (e.g., without limitation, needs improvement; poor; good, respectively) of the project manager.

Regardless of the particular project manager, the same project manager scorecard 4 is preferably employed for each different project of the provider. The predetermined project phases 6,8,10,12 of FIG. 1 and the predetermined project milestones, such as 50,52,54,56,58 of FIG. 3B, are objectively determined from, for example, “best practices” of a wide range of different projects. The actual points 96 of FIGS. 3A-3C for each of those predetermined project milestones are preferably subjectively determined by the evaluator of the project manager based upon all objective data at hand. In FIG. 5, each of the total points 106 (FIGS. 3A-3C) for the different projects are preferably employed to evaluate the project manager.

Referring again to FIGS. 3A-3C, financial review with customer 64 considers: Has a formal communication been sent to and agreed to by the customer regarding the financial status of the project? Is there any retention or open items that are holding up payment to either the distributor (e.g., without limitation, a “middle man”; an electrical wholesaler) or to the provider? Full points should only be awarded where this communication is formal or a written confirmation of a verbal agreement.

Customer survey 68 is primarily a back to the front office focused survey. The objectives are to gain feedback on things the provider could improve on, but also (very important), to ensure that the customer recognizes the value of the project management service in order to set up future business.

### EXAMPLE 2

Customer satisfaction is preferably measured by three example surveys 48,58,68 that are done during the course of a project. Hence, the provider can compare and link relatively strong performance on the project scorecard 4 at sub-totals 100,102,104 to relatively high customer satisfaction ratings in these surveys. By doing the surveys 48,58,68 at different points in the project and corresponding to the predetermined project phases 8,10,12, respectively, of the scorecard 4, the provider can use customer satisfaction as another measure of project manager effectiveness and of the overall effectiveness of the disclosed evaluation method. Linking relatively high scores from the scorecard 4 to both improved financial performance and increased customer satisfaction is also employed. For example, for ease of comparison and linking, the customer satisfaction ratings can be normalized to the predetermined potential values 74,76,78.

The disclosed method drives consistency and profitability into project management. This is particularly beneficial for a provider since it favorably impacts the profitability of the projects of the provider. This is also very beneficial for a customer of the provider since it favorably impacts performance of the project on or suitably close to project schedule, thereby providing documentation and defense for coordination of trade issues associated with the customer's related projects from different providers.

Preferably, the scorecard 4 and the monthly report format 112 are suitably output by, for example, being manually or automatically printed on hard copy, although it will be appreciated that such information may be displayed, stored, be computer modified, or be combined with other data. All such processing shall be deemed to fall within the terms “display” or “displaying” as employed herein.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A method of evaluating a project manager of a project of a provider, said project being for a customer, said method comprising:
utilizing a project manager scorecard comprising a plurality of predetermined project phases which are common to a plurality of different projects;
including with each of said predetermined project phases a plurality of predetermined project milestones which are common to said different projects;
pre-assigning a potential value to each of said predetermined project milestones for said different projects;
evaluating said project manager with respect to said predetermined project milestones and responsively assigning an assigned value, which is less than or equal to the potential value, for each of said predetermined project milestones;
determining a sum of the assigned value for each of said predetermined project milestones; and
evaluating performance of said project manager on said project of the provider based upon said sum.

2. The method of claim 1 further comprising
employing as said predetermined project phases a vision and set-up phase, a managing information phase, a managing equipment phase and a close out and feedback phase.

3. The method of claim 1 further comprising
providing an incentive plan for the project manager as a function of said sum.

4. The method of claim 3 further comprising
assessing risk of said project of the provider as part of said incentive plan.

5. The method of claim 1 further comprising
employing managing equipment and approving information related to said equipment as at least some of said predetermined project phases.

6. The method of claim 1 further comprising
determining financial performance of said project of the provider; and
correlating said sum to said determined financial performance.

7. The method of claim 1 further comprising
employing the same project manager scorecard for each of said different projects;
objectively determining said predetermined project phases;
objectively determining said predetermined project milestones; and
subjectively assigning the assigned value for each of said predetermined project milestones of said project of the provider.

8. The method of claim 1 further comprising
employing a number of said predetermined project milestones being related to a number of persons responsible to said provider and a number of persons responsible to said customer.

9. The method of claim 1 further comprising
tracking progress against said predetermined project milestones as said project of the provider progresses.

10. The method of claim 1 further comprising
employing said sum for a number of said different projects to evaluate said project manager.

11. The method of claim 1 further comprising
providing a training and development program for the project manager based upon at least some of said predetermined project milestones and each said assigned value therefor.

12. The method of claim 1 further comprising
providing a incentive plan for the project manager based upon said sum.

13. The method of claim 1 further comprising
considering changes to financial performance of said project of the provider from when the project manager is assigned to said project of the provider to when said project of the provider is completed.

14. The method of claim 1 further comprising
employing said sum for a number of said different projects; and
trending said sum versus financial performance of said different projects.

15. The method of claim 1 further comprising
providing a periodic report for the project manager including said sum for said project of the provider; and
including with said periodic report a sum of assigned values for at least another one of said different projects.

16. The method of claim 15 further comprising
including with said periodic report a plurality of sub-totals of each of said assigned value for each of the predetermined project phases for said project of the provider and for said at least another one of said different projects.

17. The method of claim 16 further comprising
displaying said sub-totals and said sum for said project of the provider and for said at least another one of said different projects with a corresponding indicator of the performance of said project manager.

18. The method of claim 17 further comprising
selecting said corresponding indicator from a plurality of different indicators corresponding to relative performance of said project manager.

19. The method of claim 18 further comprising
selecting said different indicators from a plurality of different colors.

20. The method of claim 1 further comprising
measuring customer satisfaction through a plurality of surveys during said project of the provider, each of said surveys corresponding to one of said predetermined project phases; and
linking the measured customer satisfaction of each of said surveys to a sum of the assigned value for the predetermined project milestones of a corresponding one of said predetermined project phases.

21. A method of evaluating a project manager of a plurality of different projects of a provider, said projects being for a number of customers, said method comprising:
utilizing a project manager scorecard comprising a plurality of predetermined project phases which are common to said different projects;
including with each of said predetermined project phases a plurality of predetermined project milestones which are common to said different projects;
pre-assigning a potential value to each of said predetermined project milestones;
evaluating said project manager with respect to said predetermined project milestones and responsively assigning an assigned value, which is less than or equal to the potential value, for each of said predetermined project milestones and for each of said different projects;
for each of said different projects, determining a sum of the assigned value for each of said predetermined project milestones; and
evaluating performance of said project manager on said different projects based upon said sum for each of said different projects.

22. The method of claim 21 further comprising
providing a periodic report for the project manager including said sum for each of said different projects; and
including with said periodic report a plurality of sub-totals of each of said assigned value for each of the predetermined project phases for each of said different projects.

23. The method of claim 22 further comprising
displaying said sub-totals and said sum for each of said different projects with a corresponding indicator of the performance of said project manager.

24. The method of claim 23 further comprising
selecting said corresponding indicator from a plurality of different indicators corresponding to relative performance of said project manager.
